(19) United States
(12) Patent Application Publication
(10) Pub. No.: US 2018/0345192 A1
(43) Pub. Date: Dec. 6, 2018

(54) VARIABLE LENGTH FILTER ELEMENTS, APPARATUS COMPRISING SUCH FILTER ELEMENTS, AND METHODS OF MAKING AND USING SUCH ELEMENTS AND APPARATUS

(71) Applicant: JONELL FILTRATION PRODUCTS, INC., BRECKENRIDGE, TX (US)

(72) Inventors: ALAN L CLARKE, MINERAL WELLS, TX (US); STEVEN G TOLLEFSON, MINERAL WELLS, TX (US)

(21) Appl. No.: 15/800,044

(22) Filed: Oct. 31, 2017

Related U.S. Application Data
(60) Provisional application No. 62/415,342, filed on Oct. 31, 2016.

(51) Int. Cl. B01D 46/00

(52) U.S. Cl. CPC B01D 46/001; B01D 46/0004; B01D 46/002; B01D 46/003; B01D 46/0005

(57) ABSTRACT

A filter member having an elongated body with a first end, with an extension member at the first end, wherein the extension member is adjustable between a first length and a second length. In one non-limiting embodiment, the extension member is threadably moveable between the first and second lengths. A filter system includes a vessel into which is positioned the filter member. A pipeline system will include the filter system.

RELATED APPLICATION DATA

This application claims priority from U.S. Provisional Patent Application Ser. No. 62/415,342, filed Oct. 31, 2016, which application is also herein incorporated by reference.

### BACKGROUND OF THE INVENTION

### 1. Field of the Invention

The present invention relates to methods, apparatus and products for filtering. In another aspect, the present invention relates to methods, apparatus and products for filtering streams of gas and/or liquids to remove solids and/or entrained liquids. In even another aspect, the present invention relates to methods, apparatus and products for filtering in which the risers for receiving the filter elements are not all the same length. In even yet another aspect, the present invention relates to methods, apparatus and products for filtering in which the filter elements may be adjustable lengthwise to accommodate risers of various lengths. In even still another aspect, the present invention relates to filter elements adjustable lengthwise to accommodate risers of various lengths, to filter systems utilizing filter elements adjustable lengthwise to accommodate risers of various lengths, to transportation systems utilizing filter elements adjustable lengthwise to accommodate risers of various lengths, and to methods of making and using the foregoing. In even yet another aspect, the present invention relates to filter systems having risers of various lengths, to filter systems utilizing filter elements adjustable lengthwise to accommodate risers of various lengths, to transportation systems utilizing filter elements adjustable lengthwise to accommodate risers of various lengths, and to methods of making and using the foregoing.

### 2. Brief Description of the Prior Art

There are a number of applications in which it is necessary to remove solids or liquids from a gas stream, liquid stream, or multi-phase stream. As a non-limiting example, solid or liquid contaminants may be present in various gas or liquid streams of a refrigeration system. As another non-limiting example, gas pipelines many times contain solid or liquid contaminants.

As a non-limiting example, the processing of natural gas commonly involves a number of processing steps that are necessary for the gas to meet the quality standards specified by the major pipeline transmission and distribution companies. Those quality standards vary from pipeline to pipeline and are usually a function of a pipeline system's design and the markets that it serves.

As a few of many standards a pipeline may specify that the natural gas (1) be within a specific range of heating value (caloric value); (2) be delivered at or above a specified hydrocarbon dew point temperature; (3) be free of particulate solids and liquid water to prevent erosion, corrosion or other damage to the pipeline; (4) be dehydrated of water vapor sufficiently to prevent the formation of methane hydrates within the gas processing plant or subsequently within the sales gas transmission pipeline; (5) contain no more than trace amounts of components such as hydrogen sulfide, carbon dioxide, mercaptans, and nitrogen; and/or (6) maintain mercury at less than detectable limits (approximately 0.001 ppb by volume) primarily to avoid damaging equipment in the gas processing plant or the pipeline transmission system from mercury amalgamation and embrittlement of aluminum and other metals.

Various apparatus and methods for removing solids and/or liquids from gas streams are well known. Quite commonly, gas filter elements are utilized for filtering dry gas streams as well as for separating solids and liquids from contaminated gas streams, or for coalescing entrained liquids from a gas stream. Often these types of gas filter elements are installed in elongated multi-stage vessels, which are in turn installed in a gas pipeline, to perform these filtering functions.

Within these vessels, the plurality of hollow elongated filter elements (may also be referred to as cartridges) are arranged in parallel fashion. Each of these filter elements engages a riser having a threaded member. This riser may be directly anchored to the vessel, or it may anchored to the top of another elongated rod member that is in turn anchored to the vessel. Generally, an end-cap is placed on the top end of the filter element, with the threaded riser member engaging a threaded opening in the middle of the end-cap. The end-cap in turn will engage an alignment grid at the end of the vessel.

There are a number of patents that relate to removing solids and/or liquids from gas streams, the follow of which are merely a small sampling.

U.S. Pat. No. 6,381,983, issued May 7, 2002, to Angelo et al., discloses an improved filter drier for a refrigeration system having a replaceable tubular filter element. A desiccant assembly is removably secured within a housing. The assembly includes a first and second molded desiccant, a hollow tubular perforated core located within said first and second molded desiccant, and a tubular filter located over said core.

U.S. Pat. No. 6,692,639, issued Feb. 17, 2004, to Spearman et al., discloses a conically shaped filtration and/or separation apparatus that is constructed from a stack of filters at least some of which are different sizes superposed above each, other, of said plurality of said filters in a fluid communicable relationship. A collapsible version of such conically shaped filter and/or separation apparatus is provided whereby a plurality of such filters are connected together using two piece interlocking or connecting end caps.

U.S. Pat. No. 6,858,067, issued Feb. 22, 2005, to Burns et al., discloses a filtration vessel for use with a rotary screw compressor that receives a compressed liquid/gas mixture from the compressor. The vessel utilizes a first stage vortex knockout region to remove bulk liquids through a circular motion that imposes centrifugal forces on the gas and liquid mixture. A coalescer region located above the vortex knockout region receives the relatively lighter fluids and separates any remaining entrained liquids from the fluids. The discharge from the filtration unit is an essentially liquid free compressed gas. The liquid discharge, in the case of lube oil can be recirculated to the compressor for another cycle.

U.S. Pat. No. 7,051,540, issued May 30, 2006, to TeGrotenhuis et al., discloses a wick-containing apparatus capable of separating fluids and methods of separating fluids.

U.S. Patent Application Publication No. 20070095746, published May 3, 2007 to Minichello et al., discloses an apparatus for filtering a gas or liquid stream such as a natural gas stream. The apparatus includes a closed vessel having a longitudinally extending length, an initially open interior, an inlet port at one extent and an outlet port at an opposite extent thereof. A partition located within the vessel interior divides the vessel interior into a first chamber and a second chamber. At least one opening is provided in the partition. A filter element is disposed within the vessel to extend from within the first chamber. A special seal structure formed of a resilient material and having conically shaped sidewalls is used to seal against one end of the filter element as well as forming a dynamic seal with the vessel riser in use.

U.S. Pat. No. 7,270,690, issued Sep. 18, 2007, to Sindel, discloses a separator vane assembly made up of a number of corrugated vanes that provide serpentine paths for the gas stream therethrough. As the gas stream flows through the serpentine paths, it changes direction and liquid in the gas stream impacts the surfaces of the vanes. The upstream section of the vane assembly has roughened surfaces to decrease the surface tension of the liquid, thereby causing the liquid to coalesce. The downstream section of the vane assembly has smooth surfaces so as to increase the surface tension of the liquid. The vane assembly is followed by filters, which capture the liquid that passes through the vane assembly. The vane assembly coalesces the liquid to enable the filters to operate more effectively.

U.S. Patent Application Publication No. 20070251876, published Nov. 1, 2007 to Krogue et al., discloses an apparatus for filtering a gas or liquid stream of impurities and to filter elements used in such an apparatus. The apparatus includes a closed vessel having a longitudinally extending length, an initially open interior, an input port at one extent and an output port at an opposite extent thereof. A partition located within the vessel interior divides the vessel interior into a first stage and a second stage. At least one opening is provided in the partition. A filter element is disposed within the vessel to extend from within the first stage. The filter element is made up of a carbon block filter media surrounded by a protective porous depth filter media.

U.S. Pat. No. 7,314,508, issued Jan. 1, 2008, to Evans, discloses a desiccant cartridge having a seal therearound for forming a proper seal between the cartridge and the canister of a receiver/dryer or accumulator assembly includes a cup extending along an axis having inner wall portion and outer wall portion connected to a transverse portion to define a chamber containing desiccant particles. A cap is secured to cup to secure the desiccant particles inside the chamber. The outer wall portion is provided with the seal that is composed of a flexible thermoplastic elastomer that is resistant to heat during welding shut of the canister.

U.S. Pat. No. 7,332,010, issued Feb. 19, 2008, to Steiner, discloses a two or three phase separator including a centrifugal separator, a demister (if a three phase separator), and a filter contained within a housing. The filter uses an outside-in flow principle. The filter includes an inner layer or a center core that defines a hollow interior. An outer layer is positioned adjacent and surrounding the inner layer. The outer layer includes a re-enforcement layer, a first particle filter layer, a coalescer layer, and a second particle filter layer. An access cover of the separator includes a cover plug, an actuator cam, a plurality of idler cam plates, and a plurality of mechanisms. The access cover cooperates with an opening and an annular groove in the housing to close off and seal the separator.

U.S. Pat. No. 7,344,576, issued Mar. 18, 2008, to TeGrotenhuis et al., discloses methods of separating fluids using capillary forces and/or improved conditions. The improved methods may include control of the ratio of gas and liquid Reynolds numbers relative to the Suratman number. Also disclosed are wick-containing, laminated devices that are capable of separating fluids.

Quite commonly in pipeline applications, it is not uncommon to see multi-stage vessels, as well as a multitude of other similar filtration vessels, that utilize solid or hollow core tubular elements, typically formed at least partially a porous filtration media. Non-limiting examples of such vessels include filtration equipment such as shown in U.S. Pat. No. 5,919,284, issued Jul. 6, 1999 or U.S. Pat. No. 6,168,647, issued Jan. 2, 2001, both to Perry, Jr. et al.

U.S. Pat. No. 5,919,284 discloses a gas filter separator coalescer and multi-stage vessel for separating liquids and solids from a gas stream and simultaneously coalescing liquids from the gas stream. The apparatus includes a closed vessel having a longitudinally extending length, an initially open interior, an input port at an extent and an output port at an opposite extent thereof. There is a partition located within the vessel interior that divides the vessel interior into a first stage and a second stage. There is at least one opening in the partition. A separator/coalescer filter element is disposed within the vessel to sealingly extend from within the first stage through the opening into the second stage. There is a chevron-type seal or an O-ring seal between the filter element and the opening. The input port, vessel interior, separator/coalescer filter element and output port together define a flow passage within the apparatus, whereby the gas stream flows into the first stage through the input port and through the filter element hollow core, thereby filtering solids out of the gas stream, separating liquids from the gas stream, and pre-coalescing liquids in the gas stream. The gas stream then flows along the hollow core past the partition and back through the filter element into the second stage, thereby coalescing liquids out of the gas stream, the gas stream then exiting the second stage through the outlet port.

U.S. Pat. No. 6,168,647 discloses an apparatus for separating liquids and solids from a gas stream and simultaneously coalescing liquids from the gas stream. The apparatus includes a closed vessel having a longitudinally extending length, an initially open interior, an input port at an extent and an output port at an opposite extent thereof. There is a partition located within the vessel interior that divides the vessel interior into a first stage and a second stage. There is at least one opening in the partition. A separator/coalescer filter element is disposed within the vessel to sealingly extend from within the first stage through the opening into the second stage. There is a chevron-type seal or an O-ring seal between the filter element and the opening. The input port, vessel interior, separator/coalescer filter element and output port together define a flow passage within the apparatus, whereby the gas stream flows into the first stage through the input port and through the filter element hollow core, thereby filtering solids out of the gas stream, separating liquids from the gas stream, and pre-coalescing liquids in the gas stream. The gas stream then flows along the hollow core past the partition and back through the filter element into the second stage through a louvered impingement baffle, thereby coalescing liquids out of the gas stream, the gas stream then exiting the second stage through the outlet port. The louvered impingement baffle conditions the gas stream to create a scrubbing effect on any fine mist exiting the separator/coalescer filter element.

In an effort to overcome the problems of the prior art, especially the deficiencies of U.S. Pat. Nos. 5,919,284 or 6,168,647, further development was advanced in U.S. Pat. No. 7,014,685, issued Mar. 21, 2006, and U.S. Pat. No. 7,108,738, issued Sep. 19, 2006, both to Burns et al. These two patents disclose an apparatus for filtering a gas or liquid stream such as a natural gas stream. The apparatus includes a closed vessel having a longitudinally extending length, an initially open interior, an input port at one extent and an output port at an opposite extent thereof. A partition located within the vessel interior divides the vessel interior into a first stage and a second stage. At least one opening is provided in the partition. A filter element is disposed within the vessel to extend from within the first stage. The filter element is easily mounted or removed from the vessel by rotating a J-slot engagement surface on the element which mates with a post provided on a mounting structure provided on the vessel partition.

More recent developments include U.S. Pat. No. 9,566,543, U.S. Patent Publication No. 10100224065, and U.S. Patent Publication U.S. 20140165516.

U.S. Pat. No. 9,566,543, issued Feb. 14, 2017, and U.S. Patent Publication No. 20100224065, both to Clarke et al, both disclose a device for filtering a gas stream, having a vessel partitioned into a first stage and a second stage, with an opening between stages. A filter element is positioned in the opening, with ends of the filter element extending into the first and second stages. The first member is removable from the second member while the filter element is positioned in the opening, to allow for replacement with a new clean member.

U.S. Patent Publication No. 20140165516, published Jun. 19, 2014 by Clarke et al., discloses a filter system that includes a filter element having an opening and an annular shaped sealing lip surrounding the opening. The system includes an end cap engaging and covering the opening, having an annular shaped sealing edge engaging the sealing lip, and having a parallel sided cylindrical guide portion positioned within the opening, and having an elongated cavity portion having a non-threaded first portion and a threaded second portion.

However, in spite of the various advances in the prior art as noted above, there is still a problem with the current systems that is not solved by any of the above art. Specifically, many of the commercial systems employ a vessel in which the risers contained therein are of different lengths. Because not only must a first end of the filter member engage the riser but the filter member must also extend through the vessel so that the end cap positioned on the second end of the filter member engages the alignment grid. If the filter member is too short, it will not engage the alignment grid and be inoperable. If the filter member is too long, it will extend too far and prevent the vessel door from closing and/or may damage the alignment grid once the alignment grid of closed onto it.

For example, some commercially available filter systems contain a first row of riser elements that are longer than the remaining rows of riser elements (which are all of the same length). The current solution is that there are two different sizes of filter elements available commercially.

More recently, a commercial filter system was introduced requiring three different sizes of filter elements. The current solution has been to provide three different sizes of filter elements.

However, the inventors note that this creates inventory problems both in that the filter system operator and distributors need to keep an inventory of all three sizes on hand, and the manufacturer must manufacture three different sizes.

This problem will only continue to compound, as future new designs employ “n” different lengths of filter members, and manufactures are forced to make “n” different filter members of “n” different lengths.

Thus, in spite of the teachings of the prior art, there is a need in the art for a filter member that can be utilized with risers of various lengths.

There is also a need in the prior art for a filtering system that employs a filter member that can be utilized with risers of various lengths.

There is also a need in the art for a method of filtering which employs a filter member that can be utilized with risers of various lengths.

These and other needs in the art will become apparent to those of skill in the art upon review of this application.

### SUMMARY OF THE INVENTION

It is one object of the present invention to provide for a filter member that can be utilized with risers of various lengths.

It is another object of the present invention to provide for a filtering system that employs a filter member that can be utilized with risers of various lengths.

It is even another object of the present invention to provide for transportation systems that employ a filter member that can be utilized with risers of various lengths.

It is yet another object of the present invention to provide for a method of filtering which employs a filter member that can be utilized with risers of various lengths.

These and other objects of the present invention will become apparent to those of skill in the art upon review of this application.

According to a non-limiting embodiment of the present invention, there is provided an apparatus for separating liquids and solids from a gas stream and simultaneously coalescing liquids from the gas stream. The apparatus may include a vessel defining an interior with a first filter alignment member positioned in the interior. The vessel may also include a separator/coalescer filter element disposed within the vessel, the filter element comprising a first extension member movable between different lengths, with the first extension member engaging the first filter alignment member.

According to another non-limiting embodiment of the present invention, there is provided an apparatus for separating liquids and solids from a gas stream and simultaneously coalescing liquids from the gas stream. The apparatus may include a closed vessel having a longitudinally extending length, an initially open interior, an input port at an extent, an output port at an opposite extent thereof, and a first filter alignment member. The apparatus may also include partition located within the vessel interior, the partition dividing the vessel interior into a first stage and a second stage. The apparatus may also include at least one opening in the partition. The apparatus may also include a separator/coalescer filter element disposed within the vessel to sealingly extend from within the first stage through the opening into the second stage, with the filter element comprising a first extension member movable between different lengths with the first extension member engaging the first filter alignment member. Wherein, the input port, vessel interior, separator/coalescer filter element and output port together defining a flow passage within the apparatus, whereby the gas stream flows into the first stage through the input port and through the filter element hollow core, thereby filtering solids out of the gas stream, separating liquids from the gas stream, and pre-coalescing liquids in the gas stream, and wherein the gas stream then flows along the hollow core past the partition and back through the filter element into the second stage, thereby coalescing liquids out of the gas stream, the gas stream then exiting the second stage through the outlet port.

According to even another embodiment of the present invention, there is provided a separator/coalescer filter system. The system may include an elongated filter member having a first end and a second end. The system may also include an end cap positioned on one of the ends, with the end cap comprising an extension member, with the extension member being movable between different lengths.

According to still another embodiment of the present invention, there is provided a separator/coalescer filter system. The system may include a first elongated filter member having a first end and a second end. The system may also include a second elongated filter member having a first end and a second end. The system may also include a pair of mating connector members placed on the second ends of the first and second filter member and connecting the first and second filter members together. The system may also include an end cap positioned on the first end of one of the filter members, with the end cap comprising an extension member, with the extension member being movable between different lengths.

According to yet another embodiment of the present invention, there is provided a method for positioning a separator/coalescer filter element within a separator vessel. In the method, the vessel defines an interior with a first filter alignment member positioned in the interior, and the separator/coalescer filter element comprises a first extension member movable between different lengths. The method may include adjusting the length of the first extension member so that it can suitably engage the alignment member. The method may also include positioning the filter element within the separator vessel with the extension member suitable engaging the alignment member. A sub-embodiment may include, wherein the extension. member comprises a first extension section having a threaded passage and a second extension section having threads, with the second extension section threads engaging the threaded passage such that the sections are threadably movable relative to each other with rotation of the sections relative to each other, with the adjusting of step comprising rotating the sections relative to each other. Another sub-embodiment may include, wherein the filter element further comprises an end cap, the end cap defines a threaded passage, and the extension member comprises threads, with the extension member positioned within the threaded passage with the threads engaging the threaded passage such that the extension member is threadably movable within the threaded passage when the end cap and extension member are rotated relative to each other, with the adjusting of step comprising rotating the end cap and extension member relative to each other.

According to even still another embodiment of the present invention, there is provided an apparatus for separating liquids and solids from a gas stream and simultaneously coalescing liquids from the gas stream. The apparatus may include a vessel defining an interior with a filter alignment member positioned in the interior, with a first riser of a first length, and with a second riser of a second length. The vessel may also include a first separator/coalescer filter element disposed within the vessel through the first riser, the first filter element comprising a first extension member movable between different lengths, with the length of the first extension member set to accommodate the length of the first riser so that the first extension member engages the alignment member. The vessel may also include a second separator/coalescer filter element disposed within the vessel through the second riser, the second filter element comprising a second extension member movable between different lengths, with the length of the second extension member set to accommodate the length of the second riser so that the second extension member engages the alignment member.

Various sub-embodiments of all of the above embodiments, may include: wherein the first filter alignment member is an alignment grid; wherein the first extension member is threadably movable between a first length and a second length; wherein the extension member comprises a first extension section having a threaded passage and a second extension section having threads, with the second extension section threads engaging the threaded passage such that the sections are threadably movable relative to each other with rotation of the sections relative to each other; wherein the filter element further comprises an end cap, the end cap defines a threaded passage, and the extension member comprises threads, with the extension member positioned within the threaded passage with the threads engaging the threaded passage such that the extension member is threadably movable within the threaded passage when the end cap and extension member are rotated relative to each other; wherein the vessel comprises first and second stages, and the first extension member is positioned in the first stage; and wherein further comprising a second filter alignment member positioned in the second stage, with the filter element further comprising a second extension member movable between different lengths, with the first extension member engaging the first filter alignment member and the second extension member engaging the second extension member.

These and other embodiments of the present invention will become apparent to those of skill in the art upon review of this application.

### BRIEF DESCRIPTION OF THE DRAWINGS

The following drawings illustrate some of the many possible embodiments of this disclosure in order to provide a basic understanding of this disclosure. These drawings do not provide an extensive overview of all embodiments of this disclosure. These drawings are not intended to identify key or critical elements of the disclosure or to delineate or otherwise limit the scope of the claims. The following drawings merely present some concepts of the disclosure in a general form. Thus, for a detailed understanding of this disclosure, reference should be made to the following detailed description, taken in conjunction with the accompanying drawings, in which like elements have been given like numerals.

FIG. 1 shows a common commercially available filter vessel 100, showing access door 24, stage partition 11, various riser elements 10 extending from partition 11, and filter members 13 engaged passing through riser elements 10 with the ends of filter members 13 engaging alignment grids 20 and 21 (behind door 24 and not shown in this figure), with stage partition 11 dividing filter vessel into a first stage 3 and a second stage 4, and with filter member 13 extending from first stage 3 though riser 10 and into second stage 4.

FIG. 2 shows an enhanced view of a portion of filter vessel 100 of FIG. 1, specifically the first stage 3 side, showing, stage partition 11, various riser elements 10, tops 14 of risers, and filter member 13 engaged with risers elements 10.

FIG. 3 shows a very typical commercially available filter member 13 having on each end an end caps 15 at each end, each cap 15 with an extension member 15A that engages with their respective alignment grids 20 and 21. Referring additionally to FIG. 12, there is shown end cap 15 with extension member 15A.

FIG. 4 shows portions of filter vessel 100, specifically partition 11 with a riser 10 and first stage alignment grid 21 and second stage alignment grid 20, with filter member 13 positioned therein and extending from the first stage 3, through riser 10, and into second stage 4, with end cap extensions 15A engaging alignment grids 20 and 21.

FIG. 5 shows a commercially available filter member 113, with first stage member 113A and second stage member 113B that interlock together with an interlocking collar system comprising first stage collar 113C on the end of first stage member 113A, and second stage collar member 113D on the end of second stage member 113B, with caps 15 and extension members 15A at each end.

FIG. 6 shows portions of filter vessel 100, specifically partition 11 with a riser 10, alignment grids 20 and 21, and filter member 113 is positioned therein, with filter member 113 positioned with first stage member 113A in first stage 3, with interlocking collars 113C/113D abutted against and impeded by top 14 of riser 10, with second stage member 113B extending through riser 10 and into second stage 4, and with end cap extensions 15A engaging alignment grid 20 and 21 as shown.

FIG. 7 shows a commercial unit having a riser 10 that is 1.875 inches shorter than the other riser 10.

FIG. 8 shows the first stage 3 side of filter vessel 100 with door 24 opened to show alignment grid 21 with a top row having risers of a different length than the risers of the remaining rows, with filter element 113Q with a “red” endcap 15 for the top row (signifying the correct section lengths for the top row of risers), and filter element 113R with a “blue” endcap 15 for the remaining rows.

FIG. 9 and FIG. 10 show the first stage 3 side of filter vessel 100 with door 24 opened to show alignment grid 21 showing a plurality of filter members 13, with end caps 15, all having an extra-long extension member 15AXL (extra-long).

FIG. 11 shows a commercial system utilizing 3 different sizes of risers 10, with the “stars” making risers of 26 inches, the “diamonds” making risers that are 24 inches long, and the “circles” making risers of 22.25 inches.

FIG. 12 shows end cap 15 with extension member 15A.

FIG. 13 shows one non-limiting embodiment of adjustable end cap 115, having an adjustable extension portion 115A, with the adjustable extension portion being threadably adjustable between a short position to a long position, with of course various positions therebetween.

FIG. 14 shows a bottom view of another non-limiting embodiment of the present invention, including end cap 215 having adjustable extension member 215A.

FIG. 15 shows a top view of the embodiment shown in FIG. 14, including end cap 215 having adjustable extension member 215A, with this adjustable extension member 215A including a threaded section 215T, with this adjustable extension member 215A including a threaded section 215T, and further including tip 206 that will extend through alignment grid 20, and engagement disc 208 for engaging with alignment grid 20.

FIGS. 16 and 17 show a broken apart views of the embodiment shown in FIG. 14, showing the end cap and adjustable extension member.

FIGS. 18 and 19 show a broken apart views of the embodiment shown in FIG. 14, adjustable extension member 215A from the top and bottom perspectives, respectively.

### DETAILED DESCRIPTION OF THE INVENTION

As discussed above, many commercially available filter vessels utilize different sizes of riser members in a single vessel. Because not only must the first end of the filter member engage the riser, a pointed end cap on the second end of the filter member must properly engage the vessels alignment grid. If the filter member is too short it will not engage the alignment grid.

If the filter element is too long, upon closing the vessel, the filter member will engage and prevent the vessel door from closing. One non-limiting embodiment of the present invention provides for a filter vessel with different lengths of risers utilizing the filter element of the present invention having an adjustable length extension member.

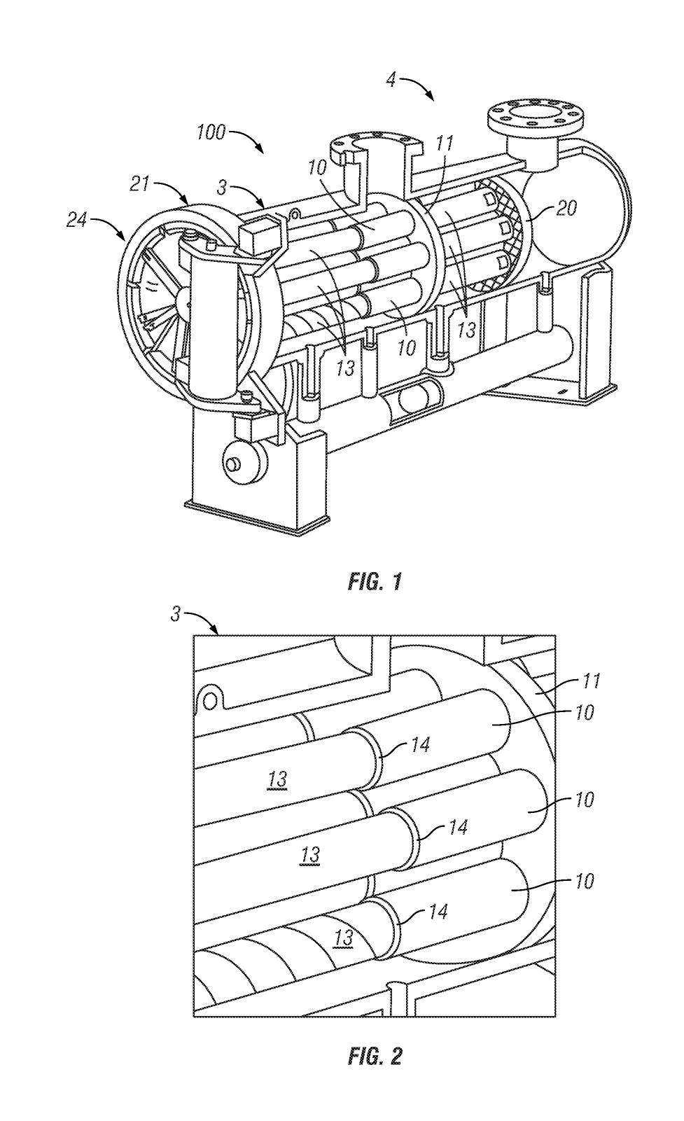

Referring now to FIG. 1, there is shown a depiction of a common commercially available filter vessel 100, showing access door 24, stage partition 11, various riser elements 10 extending from partition 11, and filter members 13 engaged passing through riser elements 10 with the ends of filter members 13 engaging first stage alignment grid 20 and second stage alignment grid 21 (behind door 24 and not shown in this figure). In some instances, filter vessel can function with a single alignment grid, usually first stage alignment grid 21. Stage partition 11 divides filter vessel into a first stage 3 and a second stage 4. Filter member 13 extends from first stage 3 though riser 10 and into second stage 4.

Referring additionally to FIG. 2, there is shown an enhanced view of a portion of filter vessel 100 of FIG. 1, specifically the first stage 3 side, showing, stage partition 11, various riser elements 10, tops 14 of risers, and filter member 13 engaged with risers elements 10.

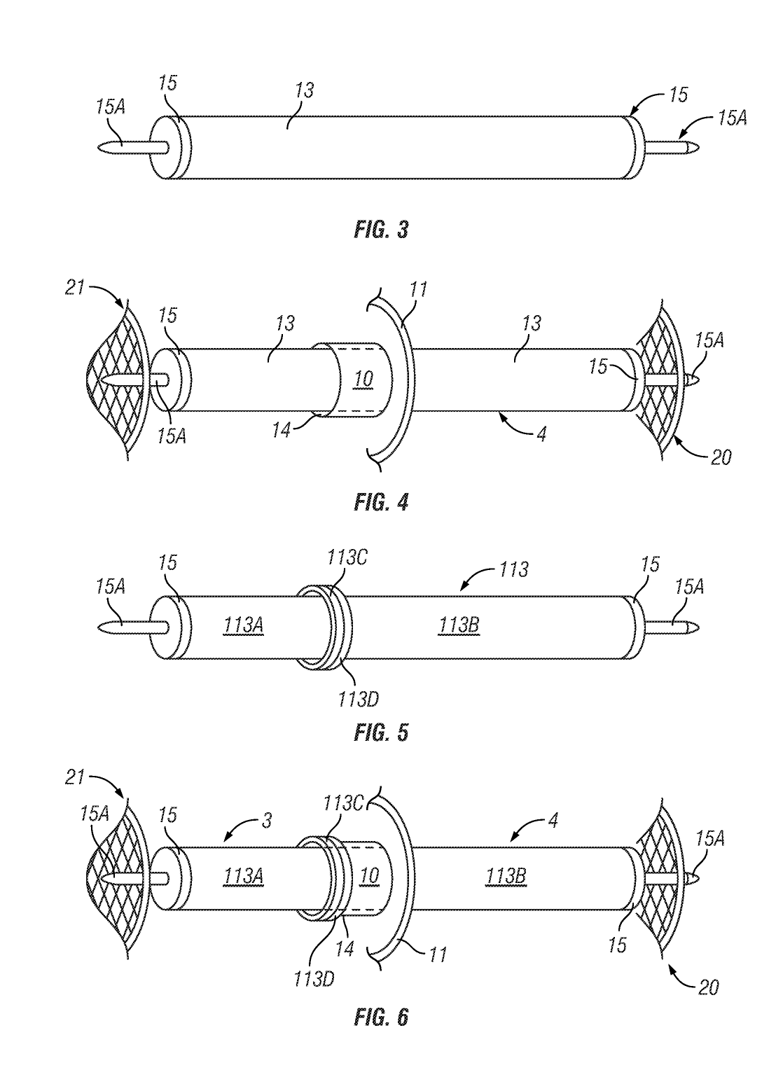

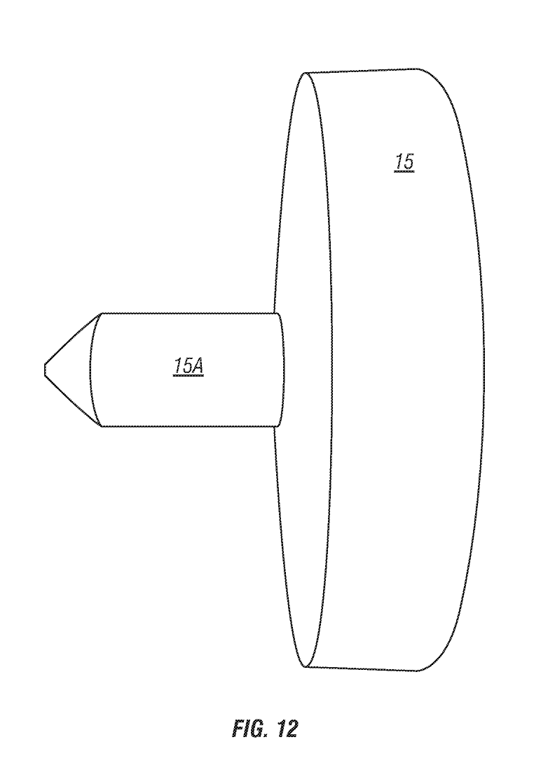

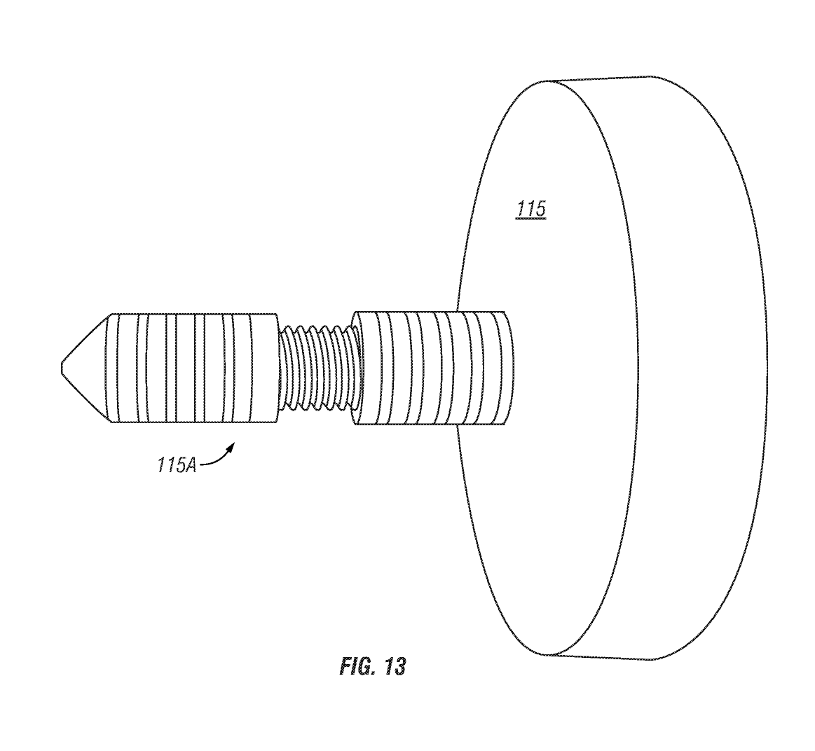

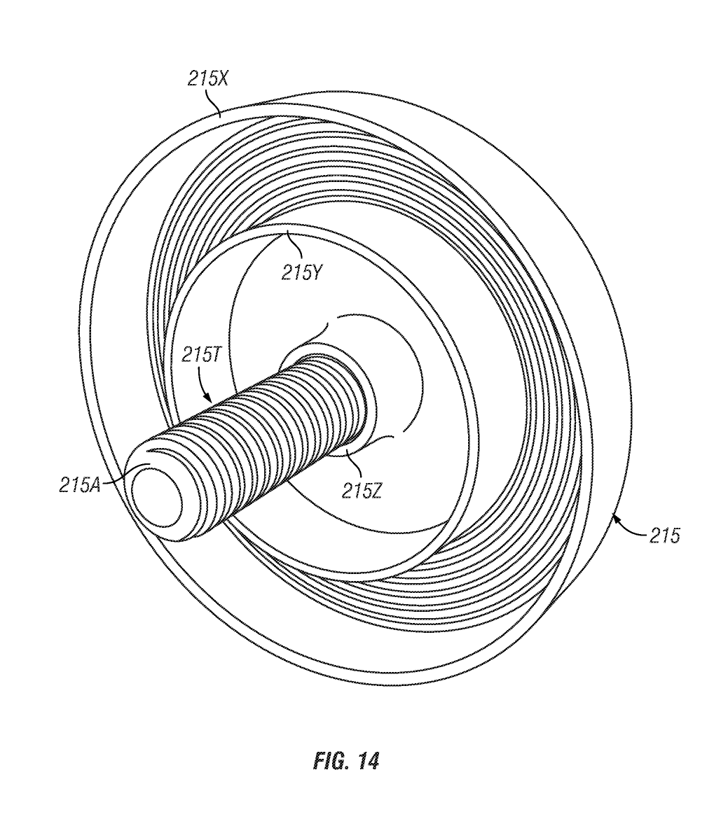

Referring additionally to FIG. 3, there is shown a very typical commercially available filter member 13 having an end caps 15 at each end, each cap 15 with an extension member 15A that engages with their respective alignment grids 20 and 21. Referring additionally to FIG. 12, there is shown end cap 15 with extension member 15A. Please note that filter member 13 does not need have to have two end caps 15, but will generally need one for each alignment grid in the vessel. In most commercially embodiments, it is believed that filter member 13 will have two end caps 15.

Referring additionally to FIG. 4, there is shown portions of filter vessel 100, specifically stage partition 11 with a riser 10 and first stage alignment grid 21 and second stage alignment alignment grid 20, with filter member 13 positioned therein. In first stage 3, end cap extension 15A will engage first stage alignment grid 21. Filter member 13 is positioned extending from the first stage 3, through riser 10, and into second stage 4, with end cap extension 15A engaging second stage alignment alignment grid 20.

In addition to the very typical commercially available filter member 13 as shown in FIG. 3, there are also commercially available filter members 113 of the type shown in FIG. 5. This filter member 113 has first stage section 113A and second stage section 113B that interlock together with an interlocking collar system comprising first stage collar 113C on the end of first stage member 113A, and second stage collar member 113D on the end of second stage member 113B. Just like filter member 13, filter member 113 includes end caps 15 on each end that includes extension member 15A for engaging alignment grids 20 and 21. This type of filter element 113 is described in more detail in U.S. Publication No. 20130055693 and U.S. Pat. No. 9,566,543, both of which are herein incorporated by reference for all their teachings, including regarding filter member 113 and filter vessel 100.

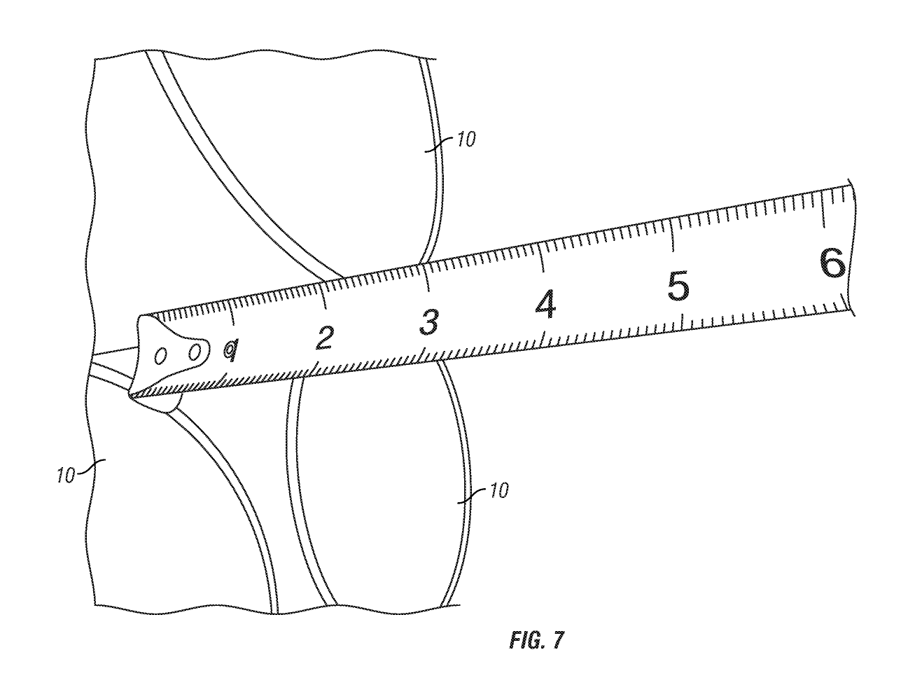

Referring additionally to FIG. 6, that shows, like FIG. 4, portions of filter vessel 100, specifically stage partition 11 with a riser 10, first stage alignment grid 21 and second stage alignment grid 20. Filter member 113 is positioned therein, wherein in first stage 3, end cap extension 15A will engage first stage alignment grid 21. Further, filter member 113 is positioned with first stage member 113A in first stage 3, with interlocking collars 113C/113D abutted against and impeded by top 14 of riser 10, with second stage member 113B extending through riser 10 and into second stage 4, and with end cap extension 15A engaging alignment grid 20.

It should be understood, that since interlocking collars 113C/113D abut against and are impeded by top 14 of riser 10, that the lengths members 113A and 113B extending from the collars to end cap 15 must be roughly equal to the distance between top 14 of riser 10 and alignment grids 20 and 21. For example, if first stage member 113A is too long it may not be possible to close access door 24 and possible damage may occur to the vessel. If first stage member 113A is too short, end cap extension 15A will not engage alignment grid 21 and filter member 113 will be unstable.

One problem that does occur commercially, is that some commercially vessels include risers 10 of various lengths, meaning that filter members 113 having different lengths for each members 113A and 113B must be utilized. One commercially available model is known to have a top row of risers that are 1.875 inches shorter. Referring now to FIG. 7, there is shown a commercial unit having a riser 10 that is 1.875 inches shorter than the other riser 10.

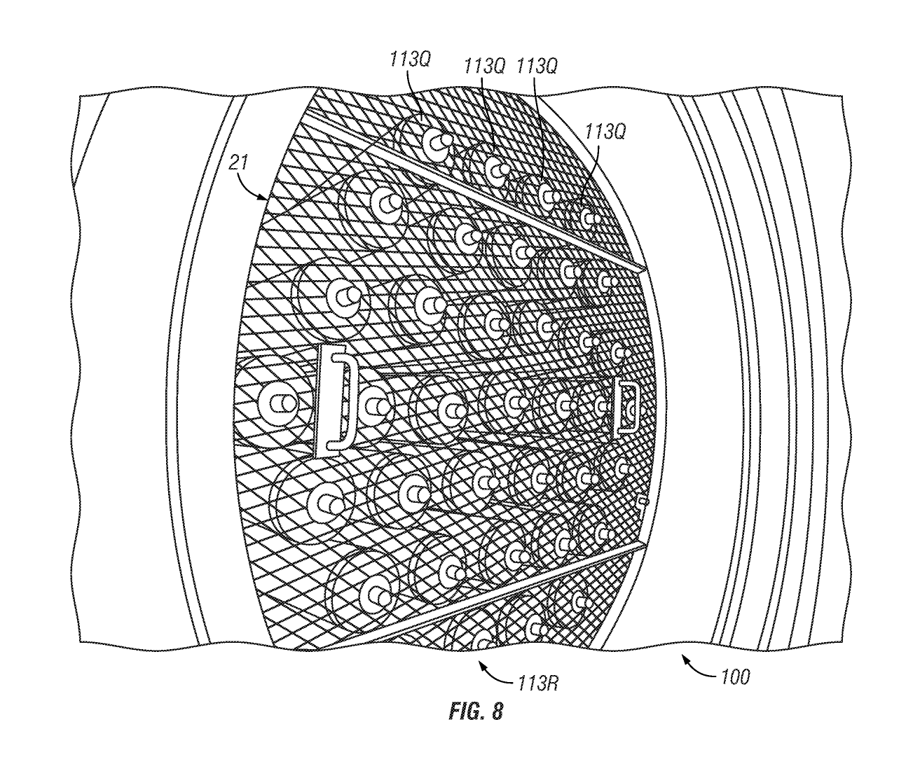

Thus, use of filter members 113 with different length risers, requires utilizing two different configured filter elements 113. Referring now to FIG. 8, there is shown the first stage 3 side of filter vessel 100 with door 24 opened showing a top row having risers of a different length than the risers of the remaining rows. The commercially solution has been to provide filter element 113Q with a “red” endcap 15 for the top row (signifying the correct section lengths for the top row of risers), and filter element 113R with a “blue” endcap 15 for the remaining risers.

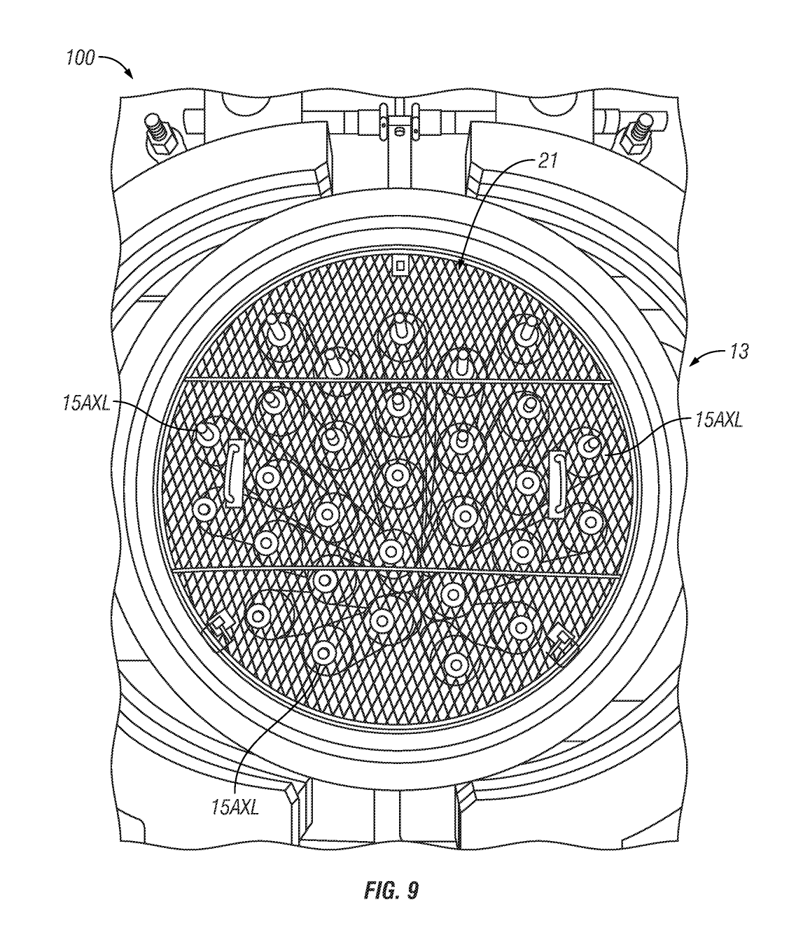

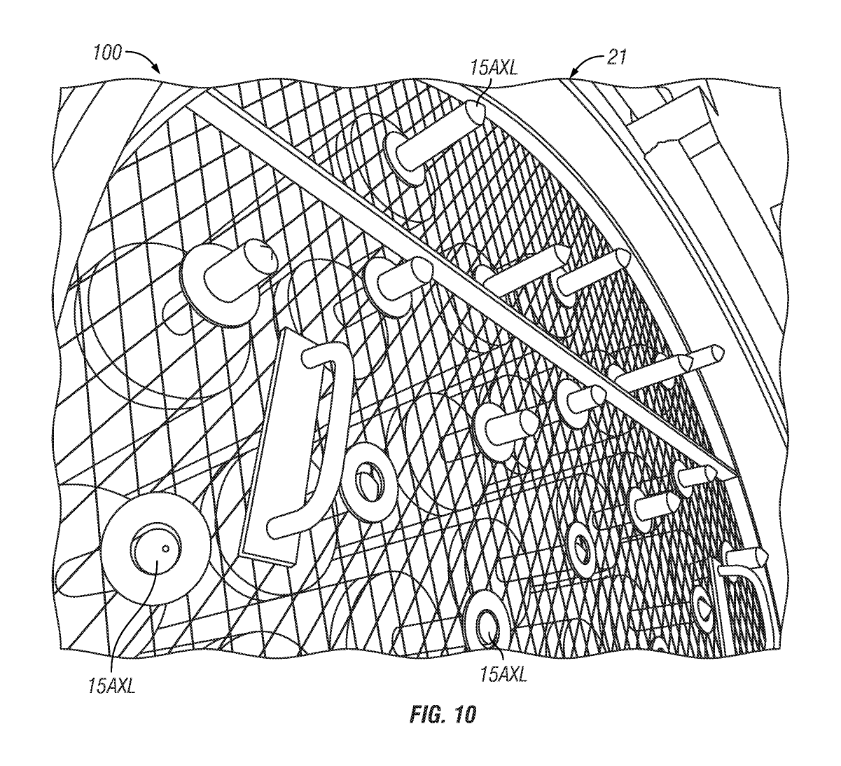

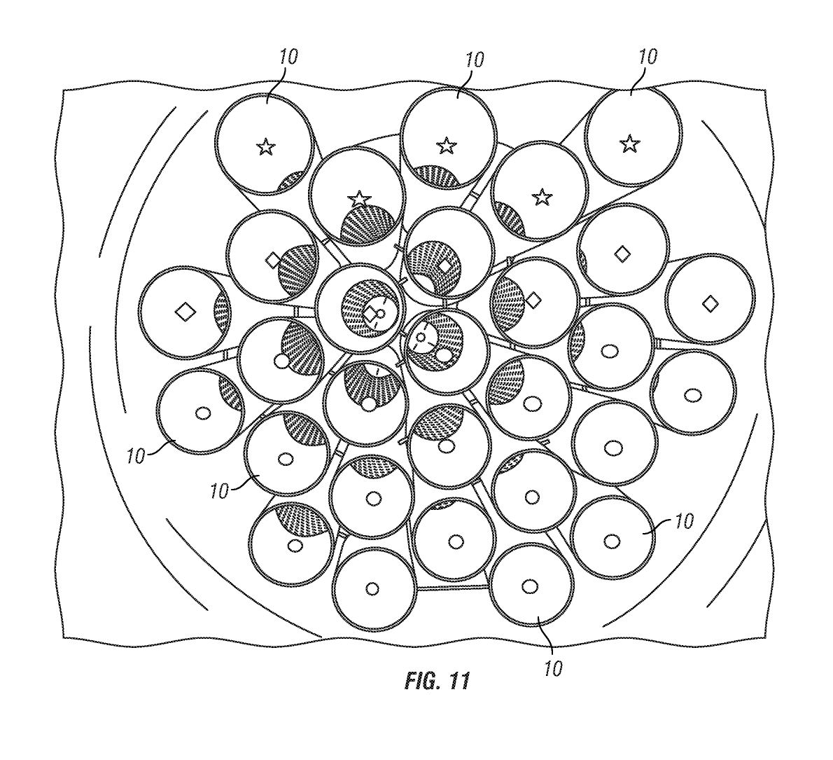

Referring now to FIG. 11, there is shown a commercial system utilizing 3 different sizes of risers 10, with the “stars” making risers of 26 inches, the “diamonds” making risers that are 24 inches long, and the “circles” making risers of 22.25 inches. The current commercial solution being to provide filter elements of three different lengths for such systems creating manufacturing and inventory problems. Another solution is to utilize a longer extension member 15A that is capable of engaging alignment grid 20. Referring now to FIGS. 9 and 10, there is shown the first stage 3 side of filter vessel 100 with door 24 opened showing alignment grid 21 showing a plurality of filter members 13, with end caps 15, all having an extra-long extension member 15AXL (extra-long). In this extra-long extension embodiment, the extension member is at least 4 inches long, preferably at least 4.25 inches long. Extension members 15AXL as shown in FIG. 9 have length of 4.25 inches. However, while this embodiment does work, notice that near the center an extension member barely reaches the grid, near the upper right the extension member had to be cut off because the door on the housing would not close, and the top clovis pin of the grid could not be inserted because the extension element was too long to allow the clevis pin to lock into place. While this certainly is a solution, it takes a lot a work to make it function.

Another non-limiting embodiment of the present invention utilize caps having different lengths of extension members.

Another non-limiting embodiment of the present invention utilize caps having interchangeable extension members of different lengths.

Another non-limiting embodiment of the present invention utilize an extension incorporating an external cylinder which slides over external cage of the element allowing for telescoping (varying length of the element).

Another non-limiting embodiment of the present invention utilize scribe marks in the extension at critical pre-determined lengths. The extension can be cut or easily broken off at the desired length.

Another non-limiting embodiment of the present invention utilize a two-piece cap. The first piece includes a main cap with a hole and internal boss arrangement to provide stability and maintain normality of the extension to the plainer surface of the cap. The second piece would be a molded extension (at max length). The extension, passes thru the hole/boss and can be pulled out or pushed in, varying length, with residual length remaining internal to the element. This cap design would incorporate an internal o-ring/u-cup inserted into a groove cut internal to the boss, for sealing and preventing bypass. The extension would incorporate a locking feature holding/maintaining a fixed length (incorporate a molded in scale/scribe indicator to quickly establish and set correct lengths)

Another non-limiting embodiment include a modification on the two-piece cap design, that is, add internal threads to the boss (around ¾×10 inch threads), and mold a new extension with external threads to screw into boss and held with a locking feature (simply a lock nut). This can be an all plastic extension, or incorporate all-thread rod (metal or plastic to the correct length). When screwed in to achieve desired overall length, remainder of extension remains internal to the element causing no external interference. Threads potentially prevent bypass and the need for an O-ring seal.

Another non-limiting embodiment of the present invention includes incorporating a hex/wrench feature to the outside of the extension in case some force is needed to screw it in or out. This feature could also be a thru-sealed off horizontal hole allowing for a rod (simple screw driver etc.) to be inserted and used as a crank arm. A blind hole could also be incorporated, allowing for a spanner wrench etc. for screwing the extension in/out of the cap/boss feature.

Other non-limiting embodiments of the present invention utilize an adjustable filter member that may be adjusted to various sizes to fit various sizes of risers.

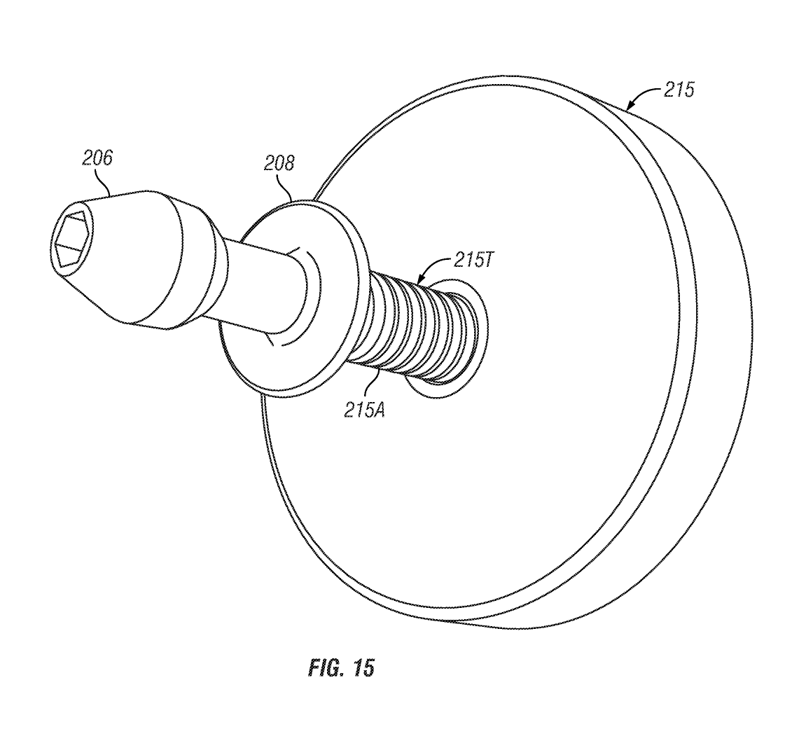

Referring now to FIG. 13, there is shown adjustable end cap 115, having an adjustable extension portion 115A. In the embodiment as shown, adjustable extension portion is threadably adjustable between a short position to a long position.

Please note that while the adjustable extension is shown as a threaded member, it should be understood that many different designs for the extension may be utilized. As non-limiting examples, the adjustable extension may be friction fitted, movable and locked into place with a set screw or similar mechanism, movable and wedged into place, movable and glued into place, set into place with interlocking teeth, movable and positioned into various slotted tracks of various lengths (for example three different tracks of various lengths), movable with extension set using one or more washers to provide the proper length of extension, spring loaded to different heights, notch breakaway extension, telescoping elements, interchangeable caps of various lengths, a closed cap with an internal o-ring and then the OD of the extension seals on the ID of the o-ring (the extension would be long enough to slide to variable lengths), or interchangeable extension members of various heights just to name a non-limiting few.

In addition to the adjustable filter member, the present invention includes a filter vessel utilizing an adjustable length filter member, methods of making an using the adjustable filter member and filter vessel, method of varying the length of the filter member, method of installing a variable length filter member into a filter vessel, and method of installing filter elements of various lengths into a filter vessel.

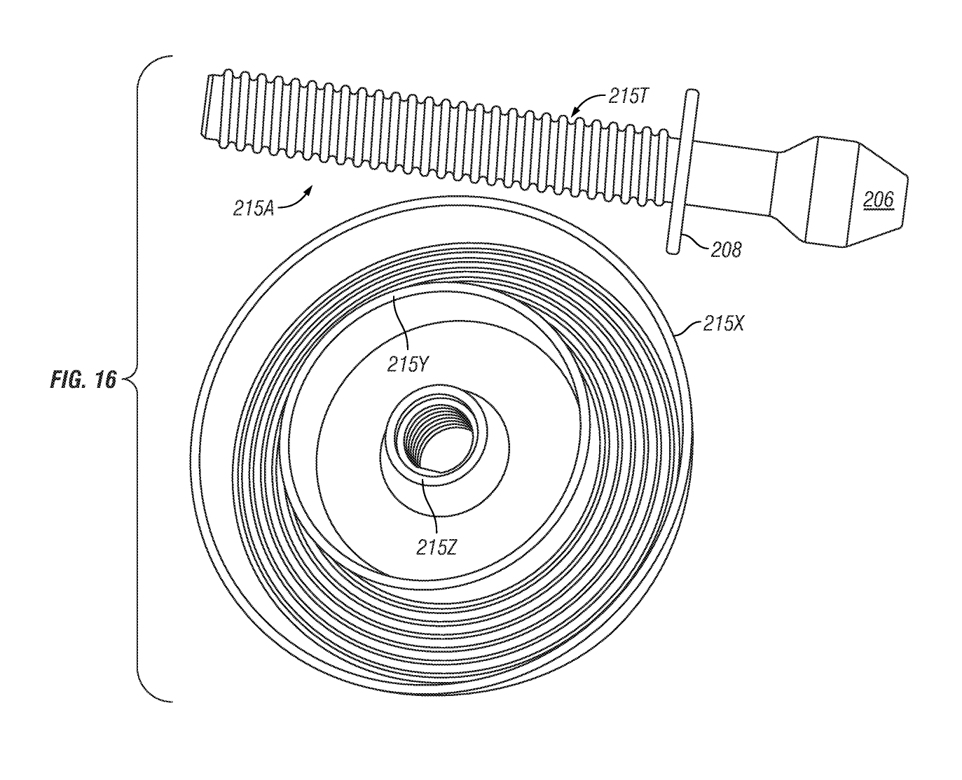

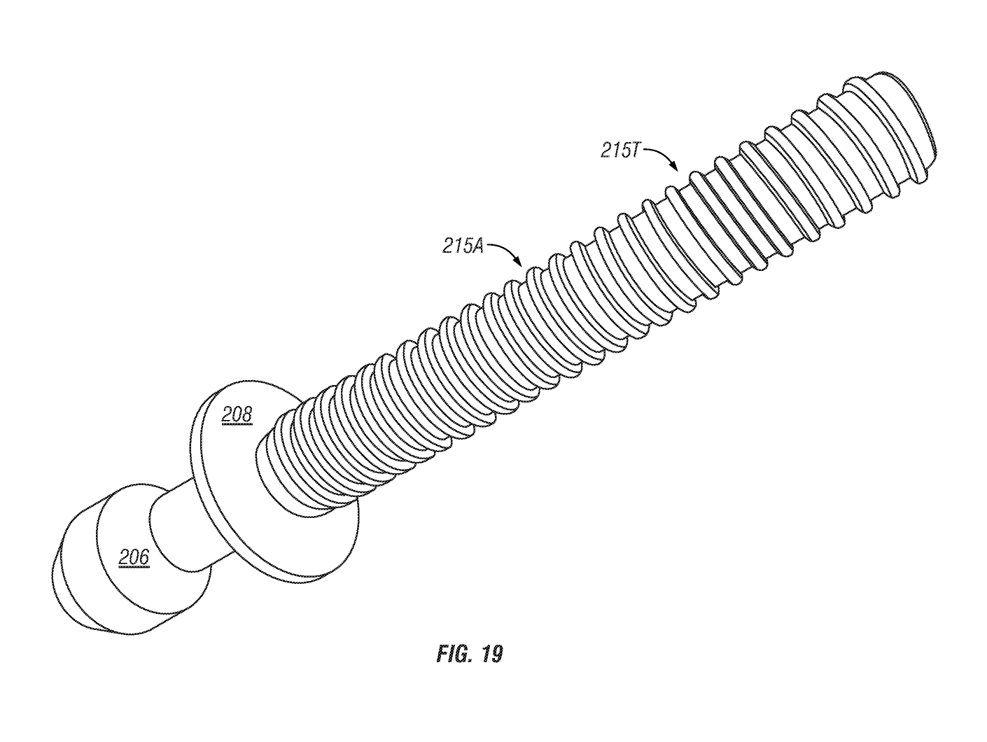

Referring now to FIGS. 14-19, there is shown another non-limiting embodiment of the present invention. Specifically, there is shown end cap 215 having adjustable extension member 215A. This adjustable extension member 215A includes a threaded section 215T. Adjustable extension member 215A further includes a tip 206 that will extend through alignment grid 20, and engagement disc for engaging with alignment grid 20.

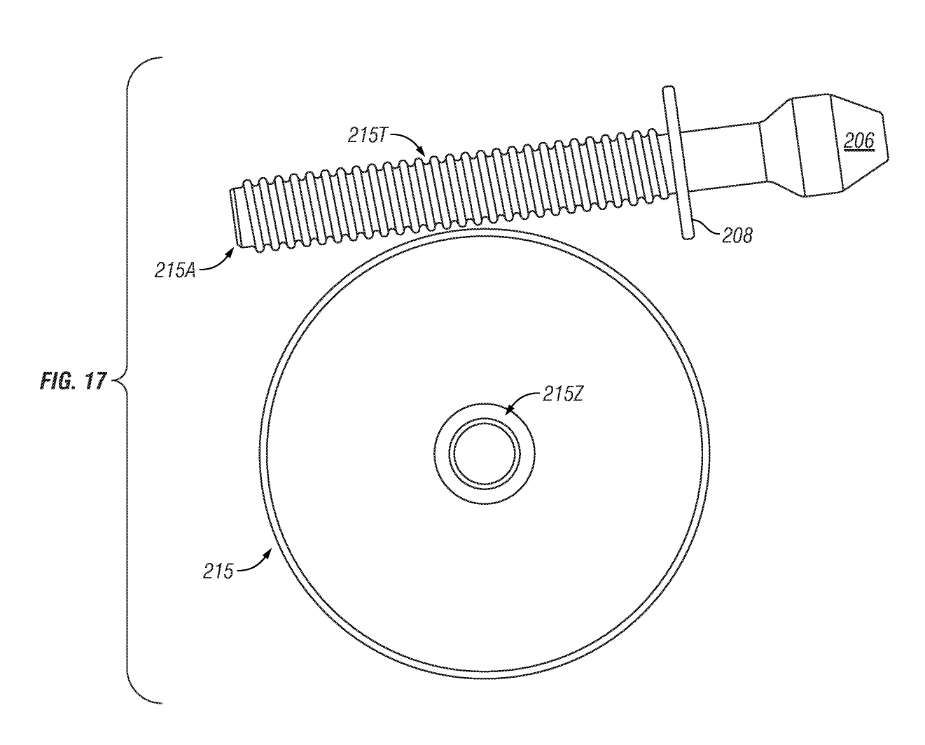

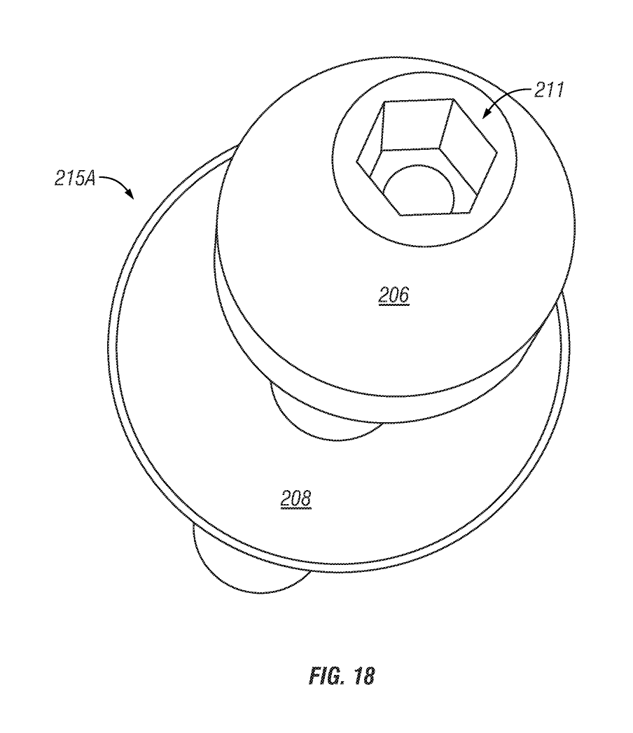

The top of end cap 215 is shown in FIGS. 15 and 17. The bottom of end cap 215 is shown in FIGS. 14 and 16. End cap 215 will be placed over and affixed to the end of the hollow filter section of the filter element. The bottom of end cap 215 includes an outer circumferential band member 215X for engaging the outer diameter of the hollow filter element, and includes an inner circumferential band member 215Y for engaging the inner diameter of the hollow filter element. In the middle of end cap 215 is threaded passage 215Z. Extension member 215A and endcap 215 are threadably engaged through their respective threaded section 21ST and threaded passage 215Z. Simply, extension member 215A is threaded into threaded passage 215Z. In the embodiment as shown, a hexagonal opening is adapted to receive a complementary shaped tool suitable for rotating extension member 215A and causing it to move up/down (in/out) of threaded passage depending on the direction of rotation.

It should be understood that the adjustable extension member of the present invention may be utilized on either one or both ends of the filter element. Even in those instances of where two alignment grids are present, it may only be necessary to utilize only one adjustable extension member. Certainly, there will be instances where an adjustable extension member is utilized on only the first stage side of the filter element, only the second stage side of the filter element, or both ends of the filter element.

The filter elements of the present invention are useful in those filter systems in which risers of different heights/lengths are present. The present invention also provides filter systems having risers of different heights/length and utilizing filter elements with adjustable length extension members.

Various methods of using the invention arise from adjusting the length of the extension member so that it will suitable engage the alignment grid when positioned in the vessel.

As a non-limiting example, a method for positioning a separator/coalescer filter element within a separator vessel, in which the vessel defines an interior with a first filter alignment member positioned in the interior, and the separator/coalescer filter element comprises a first extension member movable between different lengths, may include adjusting the length of the first extension member so that it can suitably engage the alignment member; and, may also include positioning the filter element within the separator vessel with the extension member suitable engaging the alignment member.

The exact manner of adjusting the length of the extension member will vary depending upon the type of mechanism utilized. Remember, in addition to being threadably movable, other examples include the adjustable extension may be friction fitted, movable and locked into place with a set screw or similar mechanism, movable and wedged into place, movable and glued into place, set into place with interlocking teeth, movable and positioned into various slotted tracks of various lengths (for example three different tracks of various lengths), movable with extension set using one or more washers to provide the proper length of extension, spring loaded to different heights, notch breakaway extension, telescoping elements, interchangeable caps of various lengths, a closed cap with an internal o-ring and then the OD of the extension seals on the ID of the o-ring (the extension would be long enough to slide to variable lengths), or interchangeable extension members of various heights just to name a non-limiting few.

As a non-limiting example, in those instances wherein the extension member comprises a first extension section having a threaded passage and a second extension section having threads, with the second extension section threads engaging the threaded passage such that the sections are threadably movable relative to each other with rotation of the sections relative to each other, the adjusting of step will comprise rotating the sections relative to each other.

As another non-limiting example, in those instances wherein the filter element further comprises an end cap, the end cap defines a threaded passage, and the extension member comprises threads, with the extension member positioned within the threaded passage with the threads engaging the threaded passage such that the extension member is threadably movable within the threaded passage when the end cap and extension member are rotated relative to each other, the adjusting of step will comprise rotating the end cap and extension member relative to each other.

Other apparatus and systems of the present invention include any that incorporate the filter element or filter system of the present invention. For example, a pipeline incorporating the filter system of the present invention.

All of the patents, publications, applications, articles, books, magazines, and any other prior art cited in this specification, are herein incorporated by reference.

The foregoing is considered as illustrative only of the principles of the invention. Further, since numerous modifications and changes will readily occur to those skilled in the art, it is not desired to limit the invention to the exact construction and operation shown and described.

Those skilled in the art will recognize other embodiments of the invention which may be drawn from the illustrations and the teachings herein. To the extent that such alternative embodiments are so drawn, it is intended that they shall fall within the ambit of protection of the claims appended hereto.

Having disclosed the invention in the foregoing specification and accompanying drawings in such a clear and concise manner, those skilled in the art will readily understand and easily practice the invention. It should be understood that the methods, apparatus and products of the present invention find utility in a wide range of industries and applications, including but not limited to, agriculture, biotech, biochemicals, beverage processing, chemicals, construction, crude oil environments, food processing, hydrocarbon processing, hydrocarbon production, laboratories, manufacturing, medical, mining, petrochemicals, pharmaceuticals, research, water treatment, and in any other industry or application where it is desired to filter.

The present disclosure is to be taken as illustrative rather than as limiting the scope or nature of the claims below. Numerous modifications and variations will become apparent to those skilled in the art after studying the disclosure, including use of equivalent functional and/or structural substitutes for elements described herein, use of equivalent functional couplings for couplings described herein, and/or use of equivalent functional actions for actions described herein. Any insubstantial variations are to be considered within the scope of the claims below.

We claim:

1. An apparatus for separating liquids and solids from a gas stream and simultaneously coalescing liquids from the gas stream, the apparatus comprising:
A vessel defining an interior with a first filter alignment member positioned in the interior; and,
A separator/coalescer filter element disposed within the vessel, the filter element comprising a first extension member movable between different lengths, with the first extension member engaging the first filter alignment member.

2. The apparatus of claim 1, wherein the first filter alignment member is an alignment grid.

3. The apparatus of claim 2, wherein the first extension member is threadably movable between a first length and a second length.

4. The apparatus of claim 1, wherein the extension member comprises a first extension section having a threaded passage and a second extension section having threads, with the second extension section threads engaging the threaded passage such that the sections are threadably movable relative to each other with rotation of the sections relative to each other.

5. The apparatus of claim 1, wherein the filter element further comprises an end cap, the end cap defines a threaded passage, and the extension member comprises threads, with the extension member positioned within the threaded passage with the threads engaging the threaded passage such that the extension member is threadably movable within the threaded passage when the end cap and extension member are rotated relative to each other.

6. The apparatus of claim 3, wherein the vessel comprises first and second stages, and the first extension member is positioned in the first stage.

7. The apparatus of claim 6, further comprising a second filter alignment member positioned in the second stage, with the filter element further comprising a second extension member movable between different lengths, with the first extension member engaging the first filter alignment member and the second extension member engaging the second extension member.

8. An apparatus for separating liquids and solids from a gas stream and simultaneously coalescing liquids from the gas stream, the apparatus comprising:
a closed vessel having a longitudinally extending length, an initially open interior, an input port at an extent, an output port at an opposite extent thereof, and a first filter alignment member;
a partition located within the vessel interior, the partition dividing the vessel interior into a first stage and a second stage;
at least one opening in the partition; and,
a separator/coalescer filter element disposed within the vessel to sealingly extend from within the first stage through the opening into the second stage, with the filter element comprising a first extension member movable between different lengths with the first extension member engaging the first filter alignment member;
wherein, the input port, vessel interior, separator/coalescer filter element and output port together defining a flow passage within the apparatus, whereby the gas stream flows into the first stage through the input port and through the filter element hollow core, thereby filtering solids out of the gas stream, separating liquids from the gas stream, and pre-coalescing liquids in the gas stream, and wherein the gas stream then flows along the hollow core past the partition and back through the filter element into the second stage, thereby coalescing liquids out of the gas stream, the gas stream then exiting the second stage through the outlet port.

9. The apparatus of claim 8, wherein the first filter alignment member is an alignment grid.

10. The apparatus of claim 9, wherein the first extension member is threadably movable between a first length and a second length.

11. The apparatus of claim 8, wherein the extension member comprises a first extension section having a threaded passage and a second extension section having threads, with the second extension section threads engaging the threaded passage such that the sections are threadably movable relative to each other with rotation of the sections relative to each other.

12. The apparatus of claim 8, wherein the filter element further comprises an end cap, wherein the end cap defines a threaded passage, and the extension member comprises threads, with the extension member positioned within the threaded passage with the threads engaging the threaded passage such that the extension member is threadably movable within the threaded passage when the end cap and extension member are rotated relative to each other.

13. The apparatus of claim 8, wherein the first extension member is positioned in the first stage.

14. The apparatus of claim 8, further comprising a second filter alignment member positioned in the second stage with the first filter alignment member positioned in the first stage, with the filter element further comprising a second extension member movable between different lengths, with the first extension member engaging the first filter alignment member and the second extension member engaging the second extension member.

15. A separator/coalescer filter system comprising:
An elongated filter member having a first end and a second end;
An end cap positioned on one of the ends, with the end cap comprising an extension member, with the extension member being movable between different lengths.

16. The filter of claim 15, wherein the extension member is threadably movable between different lengths.

17. The apparatus of claim 15, wherein the extension member comprises a first extension section having a threaded passage and a second extension section having threads, with the second extension section threads engaging the threaded passage such that the sections are threadably movable relative to each other with rotation of the sections relative to each other.

18. The apparatus of claim 15, wherein the end cap defines a threaded passage, and the extension member comprises threads, with the extension member positioned within the threaded passage with the threads engaging the threaded passage such that the extension member is threadably movable within the threaded passage when the end cap and extension member are rotated relative to each other.

19. A separator/coalescer filter system comprising:
A first elongated filter member having a first end and a second end;
A second elongated filter member having a first end and a second end;
A pair of mating connector members placed on the second ends of the first and second filter member and connecting the first and second filter members together;
An end cap positioned on the first end of one of the filter members, with the end cap comprising an extension member, with the extension member being movable between different lengths.

20. The filter of claim 19, wherein the extension member is threadably movable between different lengths.

21. The apparatus of claim 19, wherein the extension member comprises a first extension section having a threaded passage and a second extension section having threads, with the second extension section threads engaging the threaded passage such that the sections are threadably movable relative to each other with rotation of the sections relative to each other.

22. The apparatus of claim 19, wherein the end cap defines a threaded passage, and the extension member comprises threads, with the extension member positioned within the threaded passage with the threads engaging the threaded passage such that the extension member is threadably movable within the threaded passage when the end cap and extension member are rotated relative to each other.

23. A method for positioning a separator/coalesces filter element within a separator vessel, wherein the vessel defines an interior with a first filter alignment member positioned in the interior, and wherein the separator/coalescer filter element comprises a first extension member movable between different lengths, the method comprises:
(A) Adjusting the length of the first extension member so that it can suitably engage the alignment member; and,
(B) Positioning e filter element in the separator vessel with extension member suitable engaging the alignment member.

24. The method of claim 23, wherein the first filter alignment member is an alignment grid.

25. The method of claim 24, wherein the first extension member is threadably movable between different lengths.

26. The method of claim 24, wherein the extension member comprises a first extension section having a threaded passage and a second extension section having threads, with the second extension section threads engaging the threaded passage such that the sections are threadably movable relative to each other with rotation of the sections relative to each other, with the adjusting of step (A) comprising rotating the sections relative to each other.

27. The method of claim 24, wherein the filter element further comprises an end cap, the end cap defines a threaded passage, and the extension member comprises threads, with the extension member positioned within the threaded passage with the threads engaging the threaded passage such that the extension member is threadably movable within the threaded passage when the end cap and extension member are rotated relative to each other, with the adjusting of step (A) comprising rotating the end cap and extension member relative to each other.

28. An apparatus for separating liquids and solids from a gas stream and simultaneously coalescing liquids from the gas stream, the apparatus comprising:
A vessel defining an interior with a filter alignment member positioned in the interior, with a first riser of a first length, and with a second riser of a second length;
A first separator/coalescer filter element disposed within the vessel through the first riser, the first filter element comprising a first extension member movable between different lengths, with the length of the first extension member set to accommodate the length of the first riser so that the first extension member engages the alignment member; and,
A second separator/coalescer filter element disposed within the vessel through the second riser, the second filter element comprising a second extension member movable between different lengths, with the length of the second extension member set to accommodate the length of the second riser so that the second extension member engages the alignment member.

29. The apparatus of claim 28, wherein the filter alignment member is an alignment grid.

30. The apparatus of claim 28, wherein at least one of the extension members is threadably movable between a first length and a second length.

31. The apparatus of claim 28, wherein at least one of the extension member comprises a first extension section having a threaded passage and a second extension section having threads, with the second extension section threads engaging the threaded passage such that the sections are threadably movable relative to each other with rotation of the sections relative to each other.

32. The apparatus of claim 28, wherein at least one of the filter elements further comprises an end cap, the end cap defines a threaded passage, and the extension member comprises threads, with the extension member positioned within the threaded passage with the threads engaging the threaded passage such that the extension member is threadably movable within the threaded passage when the end cap and extension member are rotated relative to each other.
